(19) United States
(12) Patent Application Publication
(10) Pub. No.: US 2010/0072025 A1
(43) Pub. Date: Mar. 25, 2010

(54) CONVEYOR SWITCH FOR BAKED GOODS

(76) Inventors: Chi H. Chung, Smyrna, GA (US); Stephen R. Smith, Tucker, GA (US); Geri G. Walker, Carrollton, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/543,085

(22) Filed: Aug. 18, 2009

Related U.S. Application Data
(63) Continuation-in-part of application No. 12/472,964, filed on May 27, 2009.
(60) Provisional application No. 61/056,941, filed on May 29, 2008.

(51) Int. Cl. B65G 47/46

(52) U.S. Cl. 198/369.1

(57) ABSTRACT

A system and method of conveying objects. A switching station is operated in coordination with gaps formed in a first product stream carried on an upstream conveyor, to split the first product stream into two or more second product streams carried on downstream conveyors.

### CROSS-REFERENCE TO RELATED APPLICATION

This application is a continuation-in-part of U.S. patent application Ser. No. 12/472,964, filed May 27, 2009, which claims the benefit of U.S. Provisional Patent Application Ser. No. 61/056,941, filed May 29, 2008, the entireties of which are hereby incorporated herein by reference.

### TECHNICAL FIELD

The present invention relates generally to the field of product or package conveyance, and more particularly to a conveyor switch for baked goods, packages, and other products and materials.

### BACKGROUND

Conveyor belts, beltless conveyors, and other material transport mechanisms (“conveyors”) are used to transport various products such as baked goods, packages, and other products and materials during production, processing and packaging. It has been discovered that needs exist for switching product from one or more first conveyors to one or more second conveyors in a controlled fashion, for example to divide one or more first product streams into two or more second product streams for subsequent processing.

It is to the provision of a system and method meeting these and other needs that the present invention is primarily directed.

### SUMMARY

In example embodiments, the present invention provides a switching system and method for conveying product, such as for example hot-dog buns or other “cluster” type products wherein two or more product units are joined in an array, and a plurality of those arrays or a plurality of individual products, packages, or other products or materials are transported on a conveyor, and dividing a product stream carried by a first conveyor component into two or more product streams carried by two or more second conveyor components.

In one aspect, the present invention relates to a switching system and method. A first (or upstream) product stream is carried on a first conveyor element at a proximal end of the product line. The product stream reaches a switching station, where it is divided into two or more second (or downstream) product streams carried on second conveyor elements at a distal end of the product line. An upstream controller controls the first product stream to form periodic gaps between individual products or between clusters of products. The switch is operated via a switching controller to switch the delivery of the first product stream between the two or more second product streams in timed coordination with the gaps. One or more air surge tanks are optionally provided for speed and smooth movement of the switching carriage. A rodless pneumatic cylinder, hydraulic cylinder, or other actuator moves the belt side to side in the switching process. The system and method are preferably carried out in an automated fashion using one or more controllers linked to a computer processor having software for implementing the process resident thereon.

In another aspect, the present invention relates to a system for conveying products, said system comprising an upstream conveyor, at least two downstream conveyors, a switch between the upstream conveyor and the at least two downstream conveyors, and an upstream controller for generating gaps in a first product stream on the upstream conveyor. The switch is operable to alternate delivery of product from the upstream conveyor to one or the other of the at least two downstream conveyors in timed coordination with the gaps in the first product stream.

In still another aspect, the invention relates to a method of conveying products. The method includes generating gaps in a first product stream carried on an upstream conveyor, and operating a switch in timed coordination with the gaps in the first product stream to form at least two second product streams.

In another aspect, the invention relates to a conveyor switch including a frame defining first and second lateral sides, an inlet end and an outlet end. The conveyor switch further includes a carriage translationally mounted at the outlet end of the frame for traversing a lateral path between the first and second lateral sides of the frame, and an actuator for moving the carriage along the lateral path. The conveyor switch further includes a flexible conveyor belt extending between the inlet end and the outlet end and over the carriage, whereby actuation of the carriage causes a portion of the flexible conveyor belt proximal the outlet end to move laterally from a first position to a second position.

In another aspect, the invention relates to a conveyor system including a metering belt for delivering a product flow comprising a plurality of objects. The system further includes a conveyor switch for receiving the product flow from the metering belt, the conveyor switch having at least one inlet and at least two outlets, a flexible conveyor extending between the at least one inlet and the at least two outlets, and an actuator for switching the flexible conveyor between the at least two outlets. The system further includes at least two outlet conveyors, each outlet conveyor associated with a respective one of the at least two outlets of the conveyor switch.

In another aspect, the invention relates to a method of conveying objects from at least one source to at least two destinations. The method includes receiving the objects from the at least one source into an inlet of a conveyor switch, delivering the objects along a flexible conveyor portion of the conveyor switch, and actuating a laterally translating carriage portion of the conveyor switch to move the flexible conveyor portion from a first state wherein the objects are discharged from the conveyor switch to a first of the at least two destinations to a second state wherein the objects are discharged from the conveyor switch to a second of the at least two destinations.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view showing a switching system in a first state according to an example form of the invention.

FIG. 2 shows the switching system of FIG. 1 in a second or intermediate state.

FIG. 3 shows the switching system of FIG. 1 in a third state.

FIG. 4 is a second perspective view of a switching system according to an example form of the invention.

FIG. 5 shows the switching system of FIG. 1 with a portion of the system removed to show inner components thereof.

FIG. 6 shows an overhead plan view of an example layout of a switching system according to an example form of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

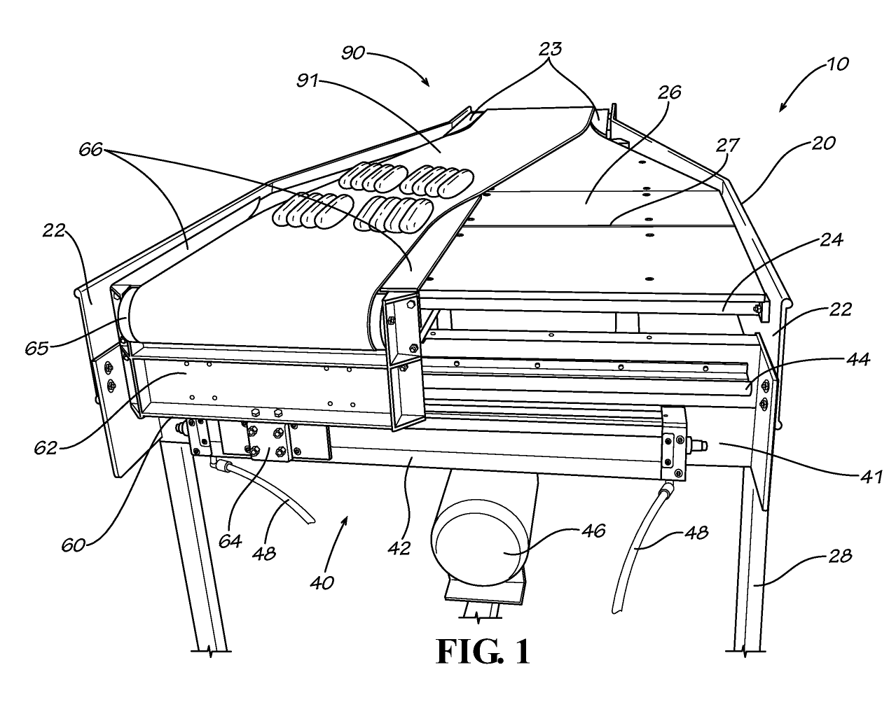

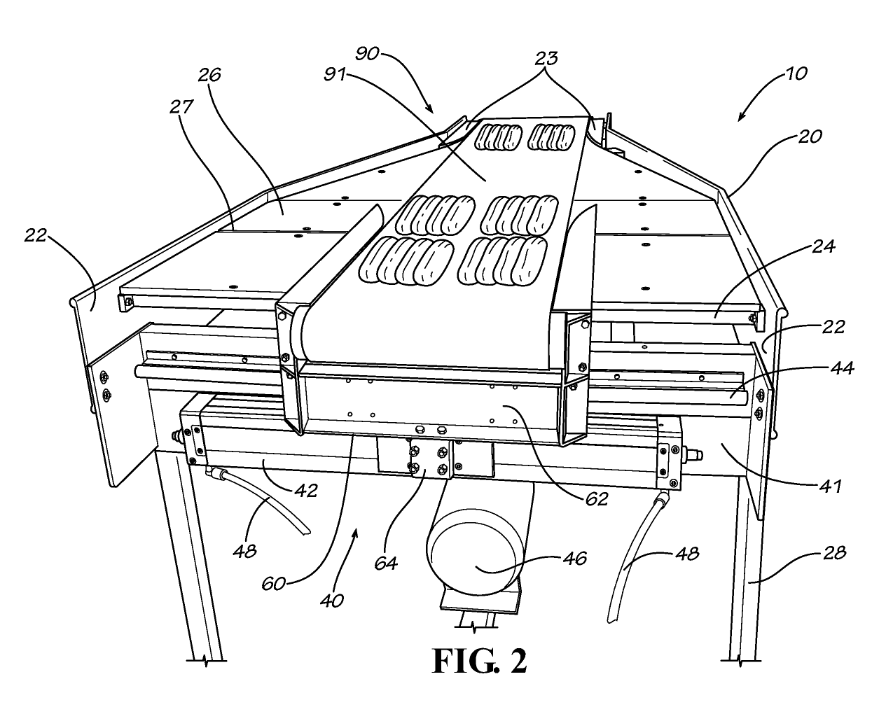

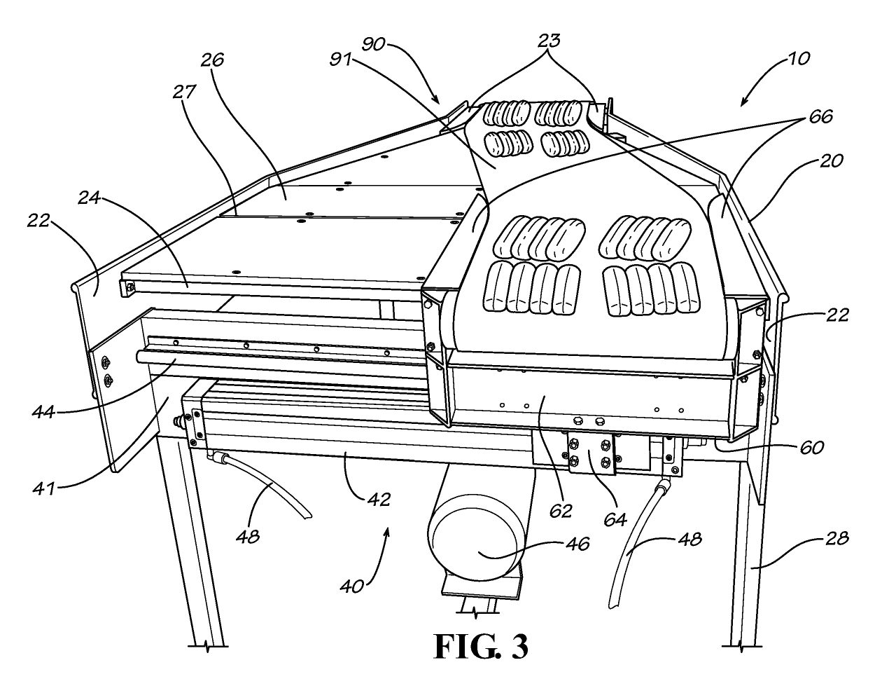

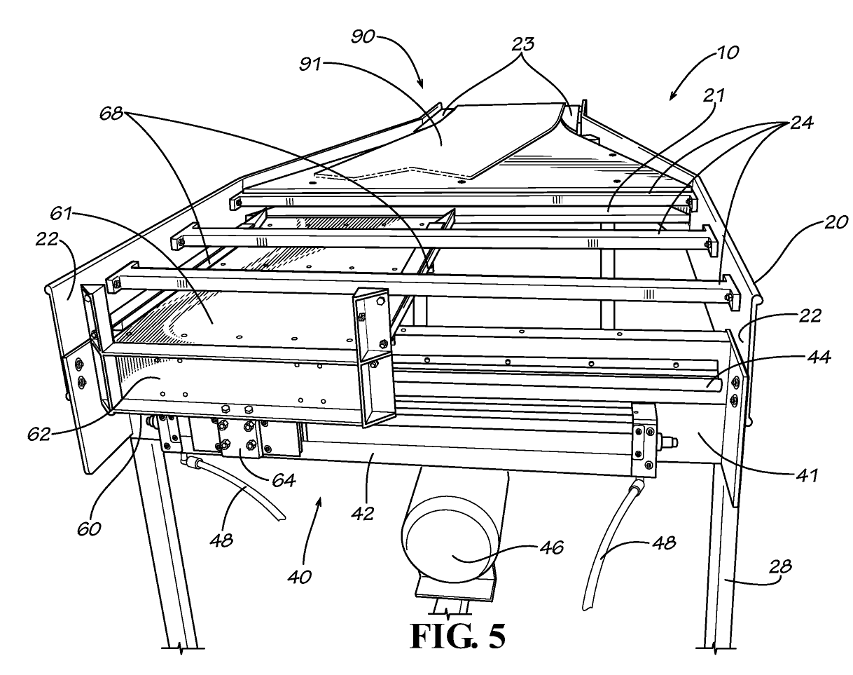

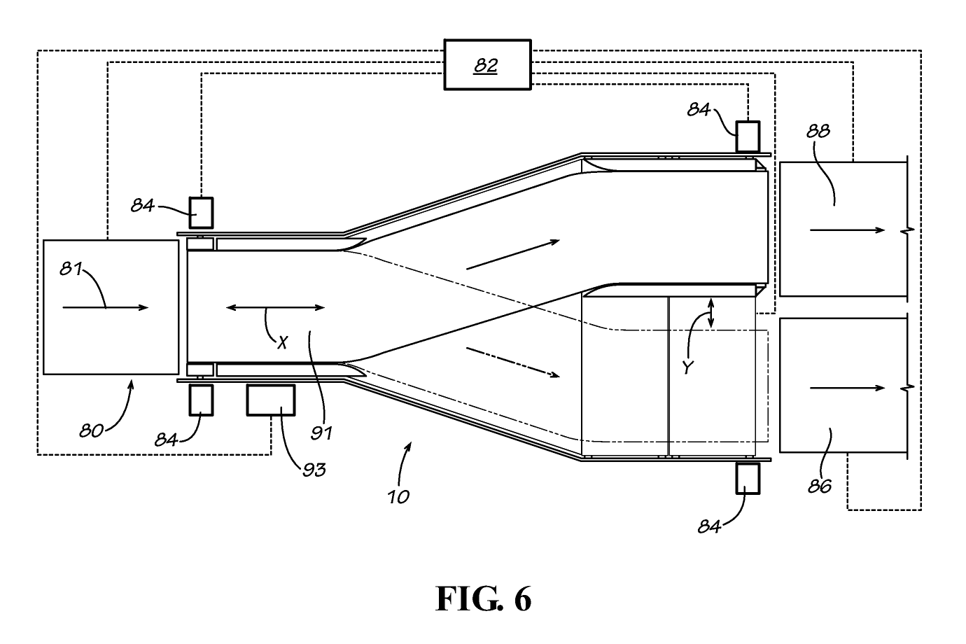

FIGS. 1-5 show a conveyor switch and demonstrate a method of operation according to an example form of the invention. In the depicted embodiment, the apparatus and method are used for conveying clustered hot dog buns, but in alternate forms the apparatus and method can be used to convey other various clustered or individual products, packages, objects, or materials. FIG. 6 demonstrates a conveyor and switching system and associated method, including a conveyor switch and a metering belt according to an example form of the invention.

The conveyor switch 10 comprises a frame 20, a switching assembly 40, and a conveyor belt system 90. A metering belt 80 is typically used in conjunction with the conveyor switch 10, upstream of the metering belt for delivering product to the inlet side of the switch. These systems and their respective subsystems will be discussed and explained in further detail in the paragraphs below. It is to be noted that in this disclosure, attached or mounted may reference any of the following methods of attachment, including, but not limited to, glue, welding, bolting, riveting, fastening, taping, screwing, etc. The components of these systems and subsystems may be manufactured from various materials, such as, but not limited to, stainless steel, ultra-high molecular weight plastic, aluminum, titanium, etc. The side-to-side or crosswise dimension denoted by arrow Y in FIG. 6 will be referred to herein as the lateral direction, and the front to back dimension denoted by arrow X in FIG. 6 will be referred to as the longitudinal or product flow direction.

As seen in FIGS. 1-3 and FIG. 5, the frame 20 comprises two frame sides 22, a plurality of support cross-member structures 24, a conveyor platform 26, a return platform 21, a pair of platform guide arms 23, and a frame stand 28. The general shape of the frame 20 from a top view resembles an inverted letter Y, where the front outlet of the frame has a wider width than the rear inlet. The frame sides 22 are located along the lateral peripheral sides of the frame 20 and are configured as to define the general aforementioned shape of the frame. Spaced along the longitudinal axis of and extending between the frame sides 22 are the support cross-member structures 24. The support structures 24 serve to support certain components of and to generally provide structural integrity to the conveyor switch. It is to be understood that support structures are optionally positioned and mounted in one or more locations throughout the conveyor switch, and reference to the support structures may refer to any of the support structures throughout the frame. In example form, the support structures 24 are metal bars having flanges on both ends that serve as attachment sites to the frame sides 22. The support structures 24 are attached to and horizontally span between the frame sides 22. Due to the unique shape of the frame, the support structures 24 may have differing dimensions based on their placement throughout the frame 20.

The conveyor platform 26 is mounted on support structures 24 by way of fastening countersunk bolts through the top of the conveyor platform 26 to the support structures 24, such that the conveyor platform 26 retains a smooth and continuous top surface. The pair of platform guide arms 23 is located near the rear inlet of the conveyor platform 26, and extends longitudinally towards the front. The guide arms taper or curve along a smooth radius at their distal ends from the rear to the front. The conveyor platform 26 may have a platform gap 27, usage of which will be discussed in further detail in the following paragraphs. The return platform 21 is mounted to support structures 24 beneath the conveyor platform 26 in a manner similar to the conveyor platform 26. The frame stand 28 is attached to the frame sides 22 and the support structures 24 and supports the frame 20 at a prescribed height above a floor or other support structure.

The switching assembly 40 comprises a switching assembly frame 41, a pneumatic sliding actuator 42, a guide rail 44, a pressurized air supply 46, a plurality of air hoses 48, and a carriage 60. The assembly frame 41 is mounted between the front end of the frame sides 22. The pneumatic sliding actuator 42 is mounted transversally to the front end of the assembly frame 41 such that the actuator 42 may actuate horizontally to either side of the assembly frame 41, and in example form comprises a rodless cylinder. In alternate forms, the actuator may take the form of a pneumatic actuator, a hydraulic actuator, an electronic or electromagnetic actuator, a manual actuator, or various other forms of actuators. Air hoses 48 connect the actuator 42 to the air supply 46, so that pressurized air is delivered to operate the actuator 42. The air supply 46 in this embodiment is delivered from a compressor, via an air surge tank, wherein the air tank is attached to the stand 28. The guide rail 44 is mounted to the assembly frame 41, displaced above and parallel to the actuator 42.

The carriage 60 comprises upper guide arms 66, lower guide arms 68, a carriage platform 61, a carriage frame 62, a mounting device 64, a shaft pulley or roller 65, and a linear bearing (not shown). The carriage frame 62 is attached to the actuator 42 by the mounting device 64. The upper guide arms 66 are attached near the top of the carriage frame 62, and extend longitudinally over the conveyor platform 26. The upper guide arms 66 taper or curve at a point distal from the front of the carriage frame. The upper guide arms 66 may have laterally-oriented rollers attached to their underside to reduce the friction between the upper guide arms 66 and the conveyor platform 26. The carriage shaft pulley or roller 65 is mounted near the top and front of the carriage frame 62. The carriage platform 61 is attached near the vertical middle of the carriage frame 62 and extends longitudinally towards the rear of the conveyor switch 10. The carriage platform 61 is horizontally level with the return platform 21. The linear bearing is attached to the rear face of the carriage frame 62 and is mounted onto the guide rail 44. The linear bearing supports the carriage 60 on the guide rail 44 and lessens the amount of friction experienced between them as the carriage is actuated from side to side.

Attached to the peripheral sides of the carriage platform 61 are the lower guide arms 68. The lower guide arms 68 taper at a distal end from the front of the carriage frame 62 much like the upper guide arms 66. The gap 27 in the conveyor platform 26 allows for the passage of a plurality of vertical bolts that connect the upper guide arms 66 to the lower guide arms 68 and the carriage platform 26. The bolts provide vertical support for the ends of the carriage platform 61 and the lower guide arms 68.

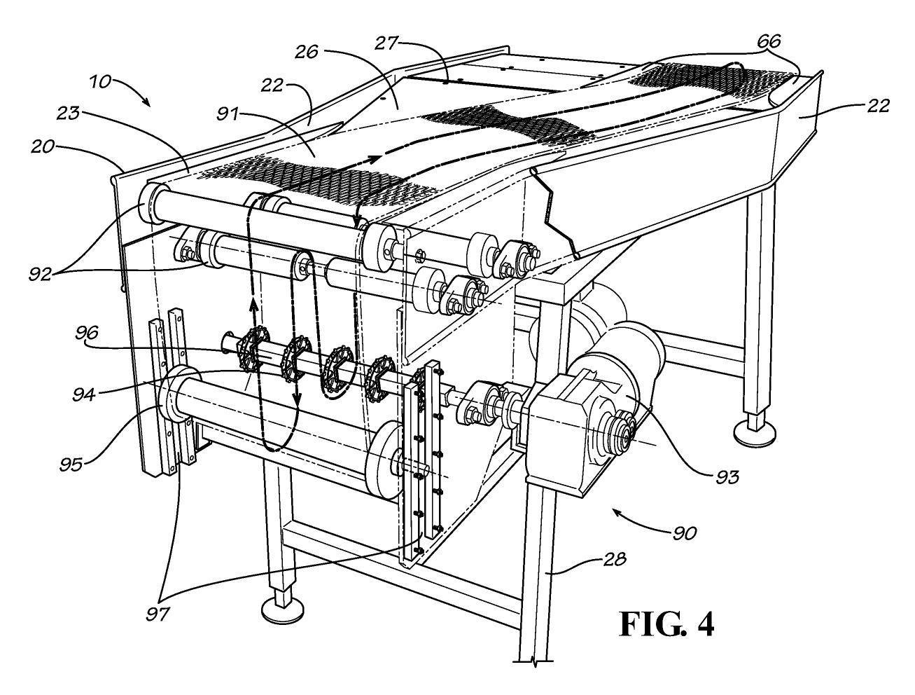

As seen in FIG. 4, the conveyor belt system 90 comprises a flexible conveyor belt 91, a plurality of bearing-mounted shaft pulleys or idler rollers 92, a conveyor belt drive motor 93, a motor output drive shaft 96, a plurality of conveyor drive sprockets 94, a take up pulley 95, and two vertical take up channels 97. The frame sides 22 extend downwards at the rear of the conveyor switch to provide structural support to the conveyor belt system. The shaft pulleys or idler rollers 92 are mounted on and in between the frame sides 22 at specific locations. The output shaft 96 is a square shaft which retains the conveyor drive sprockets 94. The conveyor belt 91 is fed sequentially in a serpentine circuit through the shaft pulleys 92, the output shaft 96, the take up pulley 95, the top of the conveyor platform 26, the carriage shaft pulley 65, the top of the carriage platform 61, the top of the return platform 21, then finally back to the shaft pulleys 92. In example form, the belt 91 is an Intralox® tight radius belt that is manufactured to have a high turning radius or any suitable form of flexible conveyor. The tapering of the upper guide arms 66, the lower guide arms 68, and the platform guide arms 23 are shaped as to provide lateral support and guidance for the flexing and turning the conveyor belt 91 experiences during operation.

As seen in FIG. 6, one or more photoelectric sensors 84 are optionally located at the front and the rear of the conveyor switch 10 positioned near the top of and on both of the frame sides 22 in order to track product flow 81. The sensors 84 electronically communicate with a computer controller 82, detecting and notifying the controller of when and where the product gaps are produced in the product flow 81 on the conveyor belt 91. The communication between the sensors 84 and the metering belt 80, as well as the gaps in product flow 81, will be discussed in further detail in the following paragraphs.

During operation of the conveyor switch 10, incoming product is received at the rear of the conveyor switch 10, now referred to as the inlet, where said product is then conveyed towards the front of the conveyor switch, now referred to as the outlet, by the translational conveying motion of the belt 91. In a first state of the conveyor switch 10, product is being conveyed from the inlet to a first lateral side of the outlet of the conveyor switch. When the need or opportunity arises to have the product be fed towards the second or opposite lateral side of the outlet of the conveyor switch 10, a switching sequence begins.

The switching sequence begins with air from the air supply 46 being selectively released to actuate the actuator 42. As depicted in FIGS. 1-3, the carriage 60, which is attached to the actuator 42, moves from the first side (left in the drawings) to the opposite second side (right in the drawings) of the conveyor switch 10 by the operation of the actuator. The resulting lateral motion of the carriage 60 slides the outlet end of the belt 91 from the first operating side to the opposite second side of the conveyor switch 10. The conveyor switch 10 is in a transitional state when the carriage 60 begins to move laterally. The belt 91 is able to laterally flex and turn while continuously conveying product during the transitional state.

The portion of the belt 91 on the conveyor platform 26 is shortened during the transitional state, due to the shortened distance the belt 91 must longitudinally traverse over the conveyor platform 26 in its intermediate position, caused by the carriage 60 momentarily laterally traversing across the middle of the conveyor platform 26 at which point the belt extends in a generally linear path without lateral bends or offsets (a straight line being the shortest path between two points). As the conveyor switch 10 traverses through the intermediate or transitional state, the excess length of the belt 91 that is no longer needed to longitudinally span the conveyor platform 26 must be taken up so that slack in the belt is not formed, which could interfere with the operation of the conveyor belt system 90. The take-up pulley 95 eliminates potential slack by means of its weight causing it to drop down within channels 97, lengthening the circuit of the belt and retaining tension on the belt. The take up pulley 95 is designed to automatically provide a calibrated amount of downward force required to take-up the excess length of the belt 91, while simultaneously allowing the conveyor belt system 90 to operate without unnecessary load on the motor 93. The ends of the take up pulley 95 are able to freely slide vertically up and down within the vertical take up channels 97 on the frame sides 22 a distance sufficient to compensate for the change in the distance traversed by the belt 91.

As seen in FIG. 6, a metering belt 80 or other product supply device is typically used in conjunction with the conveyor switch 10 to convey and feed product into the conveyor switch 10 while simultaneously producing gaps in product flow 81. The metering belt 80 is typically positioned adjacent the inlet of the conveyor switch 10, such that product discharged from the metering belt is fed into the belt 91 at the inlet of the conveyor switch 10. The metering belt 80 creates the gaps in product flow 81 by stopping and starting the metering belt or varying its speed. The gaps are created at intervals corresponding to switching sequences, so that the time span during which the gap traverses the product discharge point at the outlet is sufficient for the conveyor switch 10 to traverse from the first state to the second state without having any product on the belt 91 be compromised or fall off the belt during the switching sequence. The controller computer 82 may be in communication with the metering belt 80, the photoelectric sensors 84, the conveyor belt drive motor 93, the actuator 42, and/or the conveyor outlets 86 and 88 by wired or wireless connection, as shown by the dashed lines extending from the computer controller 82 in FIG. 6. The computer controller 82 optionally controls the movement of the metering belt in coordination with the photoelectric sensors 84, to determine when and where gaps are created in product flow 81 and to signal the actuation of the switching sequence in coordination with gaps in the product flow 81. Alternatively, the metering belt 80 may be run at variable speeds so that product is passed onto the conveyor switch 10 at a variable rate, depending on the manufacturing situation. Two separate outlet conveyor belts, 86 and 88, may be provided to convey product down the manufacturing line after product is discharged by the conveyor switch 10. The outlet conveyor belts 86 and 88 are typically positioned adjacent the outlet of the conveyor switch 10.

The conveyor switch 10 and associated system can be provided in various configurations, which include, but are not limited to, a conveyor switch that has a plurality of conveyor belt systems and a plurality of switching assemblies that result in one or more product inlets and two or more product outlets. Such embodiments may be in the form of conveyor switches with one inlet and two outlets, one inlet with three outlets, two inlets and three outlets, two inlets and four outlets, etc. Other embodiments may be in the form of a conveyor switch where orientation of the actuator may be other than horizontal, i.e. a vertical conveyor switch that switches between a first operating height at one elevation and a second lower or higher operating height or a circular conveyor switch that is able to displace its outlet along a circular path. The embodiments and described shown are for example purposes only, and are not meant to be limiting to the claims listed below.

While the invention has been described with reference to preferred and example embodiments, it will be understood by those skilled in the art that a variety of modifications, additions and deletions are within the scope of the invention, as defined by the following claims.

What is claimed is:

1. A conveyor switch comprising:
a frame defining first and second lateral sides, an inlet end and an outlet end;
a carriage translationally mounted at the outlet end of the frame for traversing a lateral path between the first and second lateral sides of the frame;
an actuator for moving the carriage along the lateral path; and
a flexible conveyor belt extending between the inlet end and the outlet end and over the carriage, whereby actuation of the carriage causes a portion of the flexible conveyor belt proximal the outlet end to move laterally from a first position to a second position.

2. The conveyor switch of claim 1, wherein the carriage comprises a carriage roller, and the flexible conveyor belt passes over the carriage roller.

3. The conveyor switch of claim 1, wherein the actuator is a pneumatic actuator.

4. The conveyor switch of claim 3, further comprising a surge tank for delivering air to the pneumatic actuator.

5. The conveyor switch of claim 3, wherein the pneumatic actuator is a rodless cylinder.

6. The conveyor switch of claim 1, further comprising a conveyor platform mounted to the frame and extending from adjacent the inlet end to adjacent the carriage for supporting the flexible conveyor belt.

7. The conveyor switch of claim 6, further comprising a return platform beneath the conveyor platform for supporting the flexible conveyor belt.

8. The conveyor switch of claim 1, further comprising a drive motor for driving the flexible conveyor belt.

9. The conveyor switch of claim 1, further comprising a take-up mechanism for adjusting the path of the flexible conveyor belt to take up slack in the flexible conveyor belt as it moves from the first position to the second position.

10. The conveyor switch of claim 19, wherein the take-up mechanism comprises a take-up pulley movably mounted to the frame.

11. The conveyor switch of claim 1, further comprising at least one sensor for sensing a gap in product flow along the flexible conveyor belt and initiating actuation of the carriage.

12. A conveyor system comprising:
a metering belt for delivering a product flow comprising a plurality of objects;
a conveyor switch for receiving the product flow from the metering belt, the conveyor switch having at least one inlet and at least two outlets, a flexible conveyor extending between the at least one inlet and the at least two outlets, and an actuator for switching the flexible conveyor between the at least two outlets; and
at least two outlet conveyors, each outlet conveyor associated with a respective one of the at least two outlets of the conveyor switch.

13. The conveyor system of claim 12, further comprising a controller for controlling the metering belt to form gaps in the product flow between the plurality of objects, and to actuate the conveyor switch in coordination with the gaps in the product flow.

14. The conveyor system of claim 12, wherein the actuator comprises a pneumatic actuator.

15. The conveyor system of claim 12, wherein the actuator drives a carriage between a first position and a second position for switching the flexible conveyor between the at least two outlets.

16. The conveyor system of claim 15, wherein the carriage comprises a carriage roller over which the flexible conveyor passes.

17. The conveyor system of claim 12, wherein the conveyor switch further comprises a drive motor for driving the flexible conveyor.

18. The conveyor system of claim 12, wherein the conveyor switch further comprises a take-up mechanism for adjusting the path of the flexible conveyor to take up slack in the flexible conveyor as it is switched between the at least two outlets.

19. The conveyor system of claim 18, wherein the take-up mechanism comprises a take-up pulley movably mounted within take-up channels.

20. A method of conveying objects from at least one source to at least two destinations, said method comprising receiving the objects from the at least one source into an inlet of a conveyor switch, delivering the objects along a flexible conveyor portion of the conveyor switch, and actuating a laterally translating carriage portion of the conveyor switch to move the flexible conveyor portion from a first state wherein the objects are discharged from the conveyor switch to a first of the at least two destinations to a second state wherein the objects are discharged from the conveyor switch to a second of the at least two destinations.
